(19) United States
(12) Patent Application Publication
(10) Pub. No.: US 2024/0136897 A1
(43) Pub. Date: Apr. 25, 2024

(54) MAGNET ARRAY METHOD, METHOD OF MANUFACTURING ROTOR, AND MAGNET ARRAY JIG

(71) Applicant: TOYOTA JIDOSHA KABUSHIKI KAISHA, Toyota-shi (JP)

(72) Inventors: Kazuhiro SATO, Toyota-shi (JP); Kei OHTA, Toyota-shi (JP)

(73) Assignee: TOYOTA JIDOSHA KABUSHIKI KAISHA, Toyota-shi (JP)

(21) Appl. No.: 18/548,249

(22) PCT Filed: Feb. 2, 2022
(86) PCT No.: PCT/JP2022/003938

§ 371 Date: Aug. 28, 2023

(30) Foreign Application Priority Data
Mar. 17, 2021 (JP) 2021-044584

(51) Int. Cl. H02K 15/03; H02K 1/2783

(52) U.S. Cl. CPC H02K 15/03; H02K 1/2783

(57) ABSTRACT

A magnet array method that can improve assemblability of magnets is provided. A magnet array method according to an aspect of the present disclosure is for arraying a plurality of magnetized magnets using a magnet array jig and includes disposing magnetic force parts of the magnet array jig at positions facing magnets to be arrayed, and arraying the magnets. The magnetic force parts are disposed so as to impart, to the magnets to be arrayed, a magnetic force for cancelling a force acting on the magnets to be arrayed.

### TECHNICAL FIELD

The present disclosure relates to a magnet array method, a method of manufacturing a rotor, and a magnet array jig.

### BACKGROUND ART

Electric motors each including a stator having a coil and a rotor having magnets are known. Patent Literature 1 discloses a technique for an outer rotor motor that can maximize torque generated at a certain current by making more effective use of magnet torque by increasing an amount of magnetic flux generated by a permanent magnet. Patent Literature 2 also discloses a technique for a periodic magnetic field generation apparatus that has a Halbach magnet array with a plurality of main pole permanent magnets magnetized in a direction of a generated magnetic field, sub-pole permanent magnets disposed between the main pole permanent magnets, and a back yoke that secures these permanent magnets.

### CITATION LIST

### Patent Literature

Patent Literature 1: Japanese Unexamined Patent Application Publication No. H11-308793
Patent Literature 2: Japanese Unexamined Patent Application Publication No. 2007-110822

### SUMMARY OF INVENTION

### Technical Problem

When a rotor is manufactured, a plurality of magnetized magnets need to be arrayed in a predetermined place on the rotor. However, when the plurality of magnetized magnets are arrayed, there is a problem that assemblability of the magnets deteriorates due to a magnetic force acting between the magnets.

In view of the above problem, an object of the present disclosure is to provide a magnet array method, a method of manufacturing a rotor, and a magnet array jig that can improve assemblability of magnets.

### Solution to Problem

A magnet array method according to an aspect of the present disclosure is for arraying a plurality of magnetized magnets using a magnet array jig. The magnet array method includes: disposing magnetic force parts of the magnet array jig at positions facing the magnets to be arrayed; and arraying the magnets. The magnetic force parts are disposed so as to impart, to the magnets to be arrayed, a magnetic force for cancelling a force acting on the magnets to be arrayed caused by the surrounding magnets.

Thus, in the present disclosure, the magnets can be arrayed while canceling the magnetic force acting on the magnets to be arrayed, so that the assemblability of the magnets can be improved.

In the above magnet array method, the magnets to be arrayed may receive the magnetic force from the surrounding magnets in a direction moving away from the magnet array jig, and the magnetic force parts may be disposed to impart, to the magnets to be arrayed, a magnetic force to attract the magnets to be arrayed.

Thus, the magnets can be arrayed while canceling the magnetic force acting on the magnets to be arrayed, so that the assemblability of the magnets can be improved.

In the above magnet array method, the magnetic force part may be provided to extend in a vertical direction, the magnets may be inserted in the vertical direction when the magnets are arrayed, and the magnet array method may further include rotating the magnetic force parts around a rotation axis extending in the vertical direction after arraying the magnets to move the arrayed magnets in a horizontal direction.

Thus, after the magnets are arrayed, the arrayed magnets can be moved in the horizontal direction by rotating the magnetic force parts, so that the positions of the arrayed magnets in the horizontal direction can be easily adjusted.

In the above magnet array method, the plurality of magnets may form a Halbach array. By forming the plurality of magnets in a Halbach array, the magnetic force of the plurality of magnets can be strengthened.

A method of manufacturing a rotor according to an aspect of the present disclosure includes arraying a plurality of magnetized magnets in a circumferential direction of the rotor using the above magnet array method. Thus, assemblability of the magnets when a rotor is manufactured can be improved.

A magnet array jig according to an aspect of the present disclosure is for arraying a plurality of magnetized magnets and includes: a jig body part formed using a non-magnetic material; and magnetic force parts provided to extend in a vertical direction of the jig body part. The magnetic force parts are disposed at positions facing the magnets when the magnets are arrayed and are configured to impart, to the magnets to be arrayed, a magnetic force for cancelling a force acting on the magnets to be arrayed caused by the surrounding magnets.

In the above magnetic array jig, the magnetic force parts are disposed at positions facing the magnets when the magnets are arrayed and are configured to cancel a force acting on the magnets to be arrayed. Thus, assemblability of the magnets can be improved.

In the above magnetic array jig, the magnetic force parts may be configured in such a way that a magnetic force direction of the magnetic force parts can be changed by rotating the magnetic force parts around a rotation axis extending in the vertical direction.

Thus, by rotating the magnetic force parts, the arrayed magnets can be moved in the horizontal direction, and thus the positions of the arrayed magnets in the horizontal direction can be easily adjusted.

In the above magnetic array jig, the magnetic force part may include: a cylindrical structure extending in the vertical direction; and a rectangular parallelepiped magnet provided inside the cylindrical structure extending in the vertical direction.

By forming the magnetic force parts using the cylindrical structure and the rectangular parallelepiped magnets in this way, the rotatable magnetic force parts can be easily formed.

### Advantageous Effects of Invention

According to the present disclosure, it is possible to provide a magnet array method, a method of manufacturing a rotor, and a magnet array jig that can improve assemblability of magnets.

### BRIEF DESCRIPTION OF DRAWINGS

FIG. 1 is a top view for explaining a magnet array jig according to an embodiment;

FIG. 2 is an enlarged top view for explaining the magnet array jig according to the embodiment;

FIG. 3 is a schematic view for explaining a magnet array method according to the embodiment;

FIG. 4 is a schematic view for explaining the magnet array method according to the embodiment;

FIG. 5 is a schematic view for explaining a magnet array method according to related art; and

FIG. 6 is a schematic view for explaining the magnet array method according to the embodiment.

### DESCRIPTION OF EMBODIMENTS

An embodiment of the present disclosure is described below with reference to the drawings.

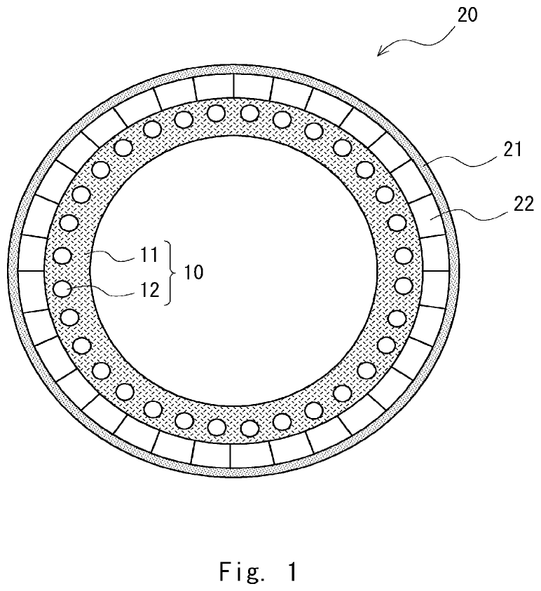

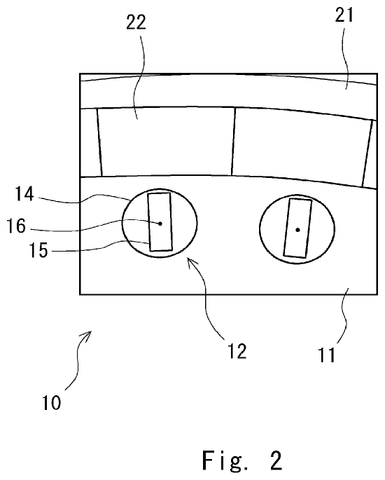

FIGS. 1 and 2 are top views and enlarged top views, respectively, for explaining a magnet array jig according to the embodiment. Hereinafter, the magnet array jig and a magnet array method according to this embodiment are described as examples, but the magnet array jig and the magnet array method according to this embodiment can be used for purposes other than the manufacture of rotors.

As shown in FIG. 1, a magnet array jig 10 is disposed on an inner circumferential side of a rotor 20. The magnet array jig 10 is used to array a plurality of magnetized magnets 22 in a circumferential direction of the rotor 20. The rotor 20 has an outer ring 21, and a plurality of magnetized magnets 22 (hereinafter also referred to simply as magnets) are arrayed on an inner circumferential side of the outer ring 21. That is, the plurality of magnets 22 are inserted vertically (perpendicular to a paper surface) so as to be aligned in the circumferential direction on the inner circumferential side of the outer ring 21. The magnetized magnets 22 are magnetized permanent magnets. For example, the plurality of magnets 22 are disposed to form a Halbach array along the circumferential direction of the outer ring 21.

The magnet array jig 10 is approximately ring-shaped and disposed on the inner circumferential side of the rotor 20. The magnet array jig 10 has a jig body part 11 and magnetic force parts 12. The jig body part 11 is formed using a non-magnetic material. That is, the jig body part 11 is formed using a non-magnetic material so that a magnetic force does not work between the magnets 22 when the magnets 22 are arrayed. The jig body part 11 can be formed using, for example, aluminum, copper, stainless steel, etc.

The magnetic force parts 12 are provided to extend vertically in the jig body part 11. In this embodiment, the magnetic force parts 12 are disposed at positions facing the magnets 22 when the magnets 22 are arrayed, and are configured to impart, to the magnets 22 to be arrayed, a magnetic force that cancels the force acting on the magnets 22 to be arrayed. Here, the force acting on the magnets 22 to be arrayed is a force caused by the surrounding magnets around the magnets 22 to be arrayed. For example, the magnetic force parts 12 are disposed at positions facing the magnets 22 when the magnets 22 are arrayed, and are configured to impart a magnetic force to the magnets 22 to attract the magnets 22.

The magnetic force parts 12 are provided to extend in the vertical direction at places adjacent to the inner circumferential surface of the rotor 20 of the jig body part 11. At this time, the magnetic force parts 12 are disposed to face the magnets 22 to be arrayed, respectively. The configuration example shown in FIG. 1 shows a configuration in which each of the magnetic force parts 12 is provided to face one of the magnets 22. That is, the magnets 22 correspond on a one-to-one basis with the magnetic parts 12. However, in this embodiment, the number of the magnetic force parts 12 may be configured to be less than the number of the magnets 22. The positions of the magnetic force parts 12 may be adjusted by rotating the jig body part 11 and moving it relative to the inner circumferential surface of the rotor 20.

The magnetic force parts 12 are configured in such a way that a magnetic force direction of the magnetic force parts 12 can be changed by rotating the magnetic force parts 12 around a rotation axis 16 (see FIG. 2) extending in the vertical direction. For example, after the magnets 22 are arrayed, the arrayed magnets 22 can be moved in the horizontal direction (i.e., the circumferential direction of the rotor 20) by rotating the magnetic force parts 12 around the rotation axis 16.

For example, as shown in FIG. 2, each of the magnetic force parts 12 can be formed using a cylindrical structure 14 extending in the vertical direction (direction perpendicular to the paper surface in FIG. 2) and a rectangular parallelepiped magnet 15 provided inside the cylindrical structure 14. The magnet 15 on the magnet array jig 10 side is disposed to face the magnet 22 on the rotor 20 side (at positions corresponding to the magnet 22 to be arrayed). With this arrangement, the force acting on the magnets 22 to be arrayed, which is caused by the surrounding magnets, can be canceled by using the magnetic force parts 12 (magnets 15), thus improving the assemblability of the magnets when the magnets 22 are inserted.

Note that the magnetic force parts 12 may be configured to be removable from the jig body part 11. In this case, the magnetic force parts 12 may be configured to be inserted into vertically extending holes formed in the jig body part 11.

In order to remove the magnet array jig 10 from the rotor 20, the magnetic force parts 12 may be rotated around the rotation axis 16 so that no magnetic force is applied between the magnets 22 on the rotor 20 side and the magnetic force parts 12 of the magnet array jig 10 (i.e., so that the magnets 22 and the magnetic force parts 12 are not attracted to each other), and then the magnet array jig 10 may be removed from the rotor 20.

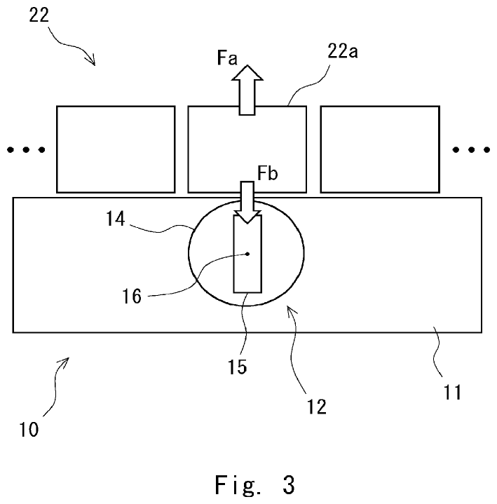

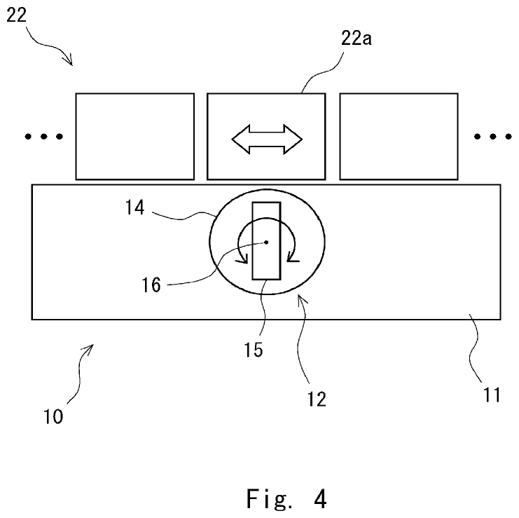

Next, the magnet array method according to this embodiment will be described with reference to FIGS. 3 and 4. For example, in the examples shown in FIGS. 3 and 4, the plurality of magnets 22 form a Halbach array. A Halbach array is an array of magnets with a direction of the magnetic poles tilted. In this embodiment, the Halbach array is not limited to a configuration in which the direction of the magnetic poles is tilted by 90 degrees. Alternatively, for example, the Halbach array may have a configuration in which the direction of the magnetic poles is tilted by 30 degrees or a configuration in which the direction of the magnetic poles is tilted by 45 degrees. In the example shown in FIG. 3, each of magnets 22a receives a magnetic force Fa in a direction moving away from the magnet array jig 10 from the surrounding magnets.

Considering this point, in this embodiment, the magnetic force parts 12 of the magnet array jig 10 are disposed at positions facing the magnets 22a to be arrayed, as shown in FIG. 3. Next, with the magnetic force parts 12 disposed, the magnets 22a are arrayed (i.e., the magnets 22a are inserted between adjacent magnets). At this time, the magnetic force parts 12 are disposed so as to impart, to the magnets 22a to be arrayed, a magnetic force that cancels the force acting on the magnets 22a to be arrayed.

In the example shown in FIG. 3, since the magnets 22a receive the magnetic force Fa in the direction moving away from the magnet array jig 10, the magnetic force parts 12 are disposed so as to impart, to the magnets 22a to be arrayed, a magnetic force Fb that attracts the magnets 22a to be arrayed. That is, the magnetic force parts 12 are disposed so as to impart, to the magnets 22a to be arrayed, the magnetic force Fb that counters the force Fa that the magnets 22a to be arrayed receive from the surrounding magnets.

In this embodiment, as shown in FIG. 4, after the magnets 22a are arrayed, the magnetic force parts 12 (magnets 15) may be rotated around the rotation axis 16 extending in the vertical direction to move the arrayed magnets 22a in the horizontal direction. Thus, in this embodiment, after the magnets 22a are arrayed, the arrayed magnets 22a can be moved in the horizontal direction by rotating the magnetic force parts 12, so that the positions of the arrayed magnets 22a in the horizontal direction can be easily adjusted.

If the magnetic force acting on the magnets 22a to be arrayed can be canceled by using the magnetic force parts 12, the configuration (combination) of the magnets 22a and the magnetic force parts 12 can be determined in any way. In addition, to simplify the drawings, only one magnetic force part 12 is shown in FIGS. 3 and 4.

As described above, when the force indicated by the arrow Fa (see FIG. 3) is applied to the magnet 22a to be arrayed, there is a problem that the assemblability of the magnets 22a deteriorates when the magnets 22a are arrayed. There is also a problem that when the magnets 22a are arrayed, the magnets 22a are brought into contact with other members, which may damage the coating covering the surface of the magnets 22a.

To solve such problems, in the disclosure according to this embodiment, as shown in FIG. 3, the magnets 22a are arrayed after the magnetic force parts 12 of the magnet array jig 10 are disposed at positions facing the magnets 22a to be arrayed. At this time, the magnetic force parts 12 are disposed to impart, to the magnets 22a to be arrayed, a magnetic force that cancels the force acting on the magnets 22a to be arrayed. Thus, in the embodiment of the present disclosure, the magnets can be arrayed while canceling the magnetic force acting on the magnets to be arrayed, so that the assemblability of the magnets can be improved.

Specifically, in the example shown in FIG. 3, the magnetic force parts 12 are disposed to impart a magnetic force to the magnets 22a to attract the magnets 22a to be arrayed. In this way, in the present disclosure, the magnets 22a are inserted while the magnets 22a are attracted to the magnetic force parts 12 of the magnet array jig 10. Therefore, the magnets 22a can be inserted while canceling the magnetic force acting on the magnets 22a caused by the surrounding magnets, so that the assemblability of the magnets can be improved. In addition, the magnets 22a can be suppressed from being brought into contact with other members when the magnets 22a are arrayed, and thus damage to the coating covering the surface of the magnets 22a can be suppressed.

In this embodiment, as shown in FIG. 4, after the magnets 22a are arrayed, the magnetic force parts 12 can be rotated around the rotation axis 16 to move the arrayed magnets 22a in the horizontal direction. Thus, in this embodiment, after the magnets 22a are arrayed, the magnetic force parts 12 can be rotated to move the arrayed magnets 22a in the horizontal direction, so that the positions of the arrayed magnets 22a can be easily adjusted in the horizontal direction.

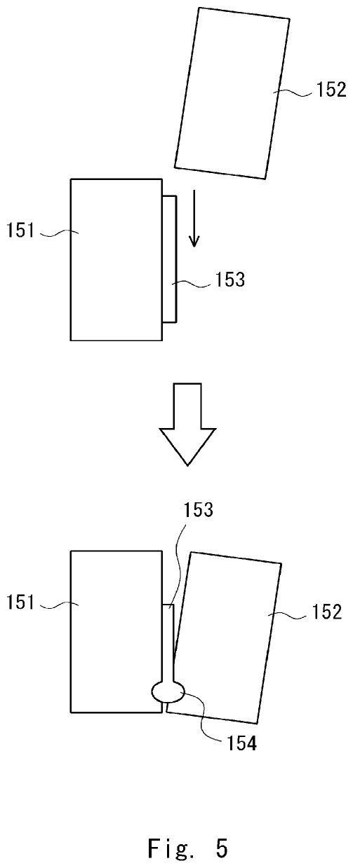

FIG. 5 is a schematic diagram for explaining a magnet array method according to related art, and shows magnets 151 and 152 as viewed from the inner circumferential side of a rotor. In the magnet array method according to the related art, when the magnet 152 is inserted with an adhesive 153 applied to one side surface of the magnet 151, the adhesive 153 applied to the side surface of the magnet 151 is scraped off by the magnet 152, and an adhesive pool 154 may occur. For this reason, there is a problem that some areas of the magnet 151 and the magnet 152 are not bonded by the adhesive 153.

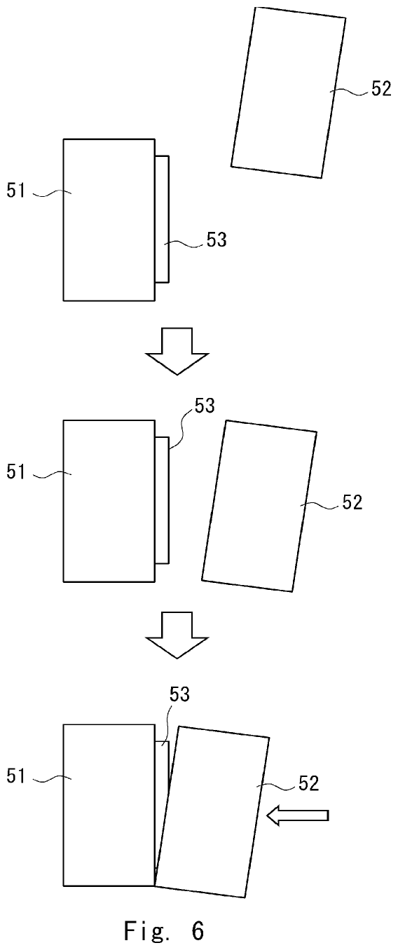

On the other hand, in the present disclosure, as shown in FIG. 6, when a magnet 52 is inserted with an adhesive 53 applied to one side surface of a magnet 51, the magnet 52 is inserted with a sufficient gap between the magnet 51 (the adhesive 53) and the magnet 52. After that, the magnetic force parts 12 of the magnet array jig 10 are rotated, the magnet 52 is moved to the magnet 51 side, and then the magnet 51 and the magnet 52 are bonded using the adhesive 53. Therefore, the adhesive 53 can be prevented from being scraped off when the magnet 52 is inserted, and the magnet 51 and the magnet 52 can be firmly bonded using the adhesive 53.

It should be noted that the present disclosure is not limited to the above embodiment and can be modified as appropriate without departing from the scope thereof. For example, each of the magnetic force parts 12 included in the magnet array jig 10 may be formed using a permanent magnet or an electromagnet. The rotor described in the above embodiment is an outer rotor type, and instead the present disclosure can also be applied to an inner rotor type rotor.

Although the present disclosure has been described above with reference to the above embodiment, the present disclosure is not limited only to the configuration of the above embodiment, and needless to say, it includes various modifications, modifications, and combinations that can be made by a person skilled in the art within the scope of the claimed disclosure.

This application claims priority on the basis of Japanese Patent Application No. 2021-44584, filed Mar. 18, 2021, the entire disclosure of which is incorporated herein by reference.

### REFERENCE SIGNS LIST

10 MAGNETIC ARRAY JIG
11 JIG BODY PART
12 MAGNETIC FORCE PART
14 CYLINDRICAL STRUCTURE
15 MAGNET
16 ROTATION AXIS
20 ROTOR
21 OUTER RING
22, 22a MAGNETIZED MAGNETS
51, 52 MAGNET
53 ADHESIVE

1. A magnet array method for arraying a plurality of magnetized magnets using a magnet array jig, the magnet array method comprising:
disposing magnetic force parts of the magnet array jig at positions facing the magnets to be arrayed; and
arraying the magnets, wherein
the magnetic force parts are disposed so as to impart, to the magnets to be arrayed, a magnetic force for cancelling a force acting on the magnets to be arrayed caused by the surrounding magnets.

2. The magnet array method according to claim 1, wherein
the magnets to be arrayed receive the magnetic force from the surrounding magnets in a direction moving away from the magnet array jig, and
the magnetic force parts are disposed to impart, to the magnets to be arrayed, a magnetic force to attract the magnets to be arrayed.

3. The magnet array method according to claim 2, wherein
the magnetic force part is provided to extend in a vertical direction,
the magnets are inserted in the vertical direction when the magnets are arrayed, and
the magnet array method further comprises rotating the magnetic force parts around a rotation axis extending in the vertical direction after arraying the magnets to move the arrayed magnets in a horizontal direction.

4. The magnet array method according to claim 1, wherein
the plurality of magnets form a Halbach array.

5. A method of manufacturing a rotor comprising arraying a plurality of magnetized magnets in a circumferential direction of the rotor using the magnet array method according to claim 1.

6. A magnet array jig for arraying a plurality of magnetized magnets comprising:
a jig body part formed using a non-magnetic material; and
magnetic force parts provided to extend in a vertical direction of the jig body part, wherein
the magnetic force parts are disposed at positions facing the magnets when the magnets are arrayed and are configured to impart, to the magnets to be arrayed, a magnetic force for cancelling a force acting on the magnets to be arrayed caused by the surrounding magnets.

7. The magnet array jig according to claim 6, wherein
the magnetic force parts are configured in such a way that a magnetic force direction of the magnetic force parts can be changed by rotating the magnetic force parts around a rotation axis extending in the vertical direction.

8. The magnet array jig according to claim 6, wherein
the magnetic force part comprises:
a cylindrical structure extending in the vertical direction; and
a rectangular parallelepiped magnet provided inside the cylindrical structure extending in the vertical direction.
